(19) United States
(12) Patent Application Publication
(10) Pub. No.: US 2008/0317540 A1
(43) Pub. Date: Dec. 25, 2008

(54) Applicator having soft applicator tip

(75) Inventor: Teng-Huei Wang, Tainan City (TW)

Correspondence Address: FROMMER LAWRENCE & HAUG, 745 FIFTH AVENUE- 10TH FL., NEW YORK, NY, 10151, US

(73) Assignee: YONYU PLASTICS CO., LTD.

(21) Appl. No.: 11/820,323

(22) Filed: Jun. 19, 2007

(51) Int. Cl. B43K 1/00

(52) U.S. Cl. 401/54; 401/88

(57) ABSTRACT

An applicator includes a tubular container, and a soft applicator tip bonded to the tubular container and having a composition including 60˜85% by weight of thermoplastic elastomer, 10˜30% by weight of polyolefin, and 5˜10% by weight of an adhesive. The adhesive is a modified polyolefin adhesive resin.

### BACKGROUND OF THE INVENTION

1. Field of the Invention

This invention relates to an applicator, more particularly to an applicator with a soft applicator tip.

2. Description of the Related Art

The structure of a conventional applicator includes a soft tube, and an applicator tip fixed to one end of the soft tube and having an opening facing outwardly. A method of producing the applicator includes forming the soft tube by extrusion to have the desired outer shape, forming the applicator tip through an injection molding or compression molding process, and, through a high-temperature and high-pressure process, melt-bonding of the plastic material of the applicator tip to the soft tube. Currently available soft tubes are mostly made of soft polyolefin, such as polyethylene (PE) or polypropylene (PP), while the applicator tips thereof are made of hard PE or PP.

However, when the conventional applicator having the hard applicator tip is used for containing lip balm, lip gloss, or lip shimmer, the applicator tip is usually indirect contact with a user's lip. Because the applicator tip is hard, it cannot provide soft and close contact with the user's lip. As such, during smearing, a liquid body squeezed from the applicator easily flows outside of the smearing area, or the smearing is not uniform.

### SUMMARY OF THE INVENTION

Therefore, the object of the present invention is to provide an applicator having a soft applicator tip that is capable of overcoming the aforementioned drawbacks of the prior art.

According to one aspect of this invention, a soft applicator tip has a composition comprising 60˜85% by weight of thermoplastic elastomer, 10˜30% by weight of polyolefin, and 5˜10% by weight of an adhesive.

According to another aspect of this invention, an applicator comprises a tubular container made of polyolefin, and a soft applicator tip bonded to the tubular container and having a composition including 60˜85% by weight of thermoplastic elastomer, 10˜30% by weight of polyolefin, and 5˜10% by weight of an adhesive.

### BRIEF DESCRIPTION OF THE DRAWING

Other features and advantages of the present invention will become apparent in the following detailed description of the preferred embodiment of the invention, with reference to the accompanying drawing, in which:

FIG. 1 is a sectional side view of an applicator according to the preferred embodiment of the present invention.

### DETAILED DESCRIPTION OF THE PREFERRED EMBODIMENT

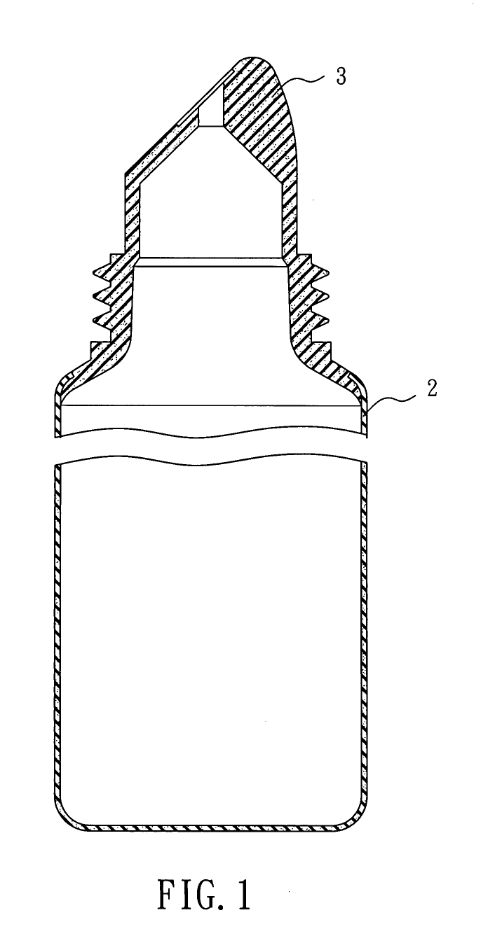

Referring to FIG. 1, an applicator according to the preferred embodiment of the present invention is shown to comprise a tubular container 2 and a soft applicator tip 3.

The tubular container 2 may be made of soft PE or PP, and is used for containing a liquid material, such as lip balm, lip gloss, lip shimmer, or the like.

Since thermoplastic elastomer (TPE) has a soft quality and good thermoplastic shaping characteristics, it is suitable for use in producing the applicator tip 3. That is, when the applicator tip 3 and the user's lip are in contact, exceptional comfort is provided to the user. However, because the applicator tip 3 of pure TPE and the tubular container 2 of PE or PP cannot be effectively melt-bonded to each other during manufacture of the applicator, TPE must therefore be combined with another chemical compounds to produce an applicator tip that can be melt-bonded with PE or PP.

Hence, the applicator tip 3 of the present invention is composed of thermoplastic elastomer (TPE), polyolefin, and an adhesive. In order for the applicator tip 3 to be effectively melt-bonded with the soft PP- or PE-made tubular container 2 during formation of the applicator of the present invention, the composition of the applicator tip 3 includes preferably 60˜85% by weight of thermoplastic elastomer, 10˜30% by weight of polyolefin, and 5˜10% by weight of an adhesive. In one example, the applicator tip 3 is made up of 80% by weight of thermoplastic elastomer, 15% by weight of polyolefin, and 5% by weight of an adhesive. The polyolefin may be PE or PP. The adhesive may be a modified polyolefin adhesive resin that is well-known under the trade name ADMER® adhesive resin.

In actual practice, when the composition of the thermoplastic elastomer is lower than 60% by weight, or the composition of the polyolefin is higher than 30% by weight, although the produced applicator tip 3 can be effectively melt-bonded with the PP- or PE-made tubular container 2, the degree of softness of the applicator tip 3 is insufficient. On the other hand, when the composition of the thermoplastic elastomer is higher than 85% by weight, or the composition of the polyolefin is lower than 10% by weight, the produced applicator tip 3 is too soft, and the melt-bonding effect with the soft tubular container 2 is poor.

Under the aforementioned conditions, aside from permitting the applicator tip 3 to have an exceptional soft quality, the applicator tip 3 can also effectively melt-bond with the soft PE- or PP-made tubular container 2.

To produce the applicator of the present invention, the tubular container 2 is first made by extruding a soft plastic material, such as PE or PP, to form a plastic sleeve that is then cut to the desired length. The cut plastic sleeve is placed in a male mold. Separately, the composition of the applicator tip 3 is mixed, and is then extruded as plastic granulates. The plastic granulates are then melted in an extruder having a temperature range of 200˜280° C. The resulting molten composition is extruded into a female mold via a nozzle. When the male mold is pressed against the female mold, the molten composition in the female mold is molded by the male and female molds to form the applicator tip 3 which is connected to the tubular container 2.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A soft applicator tip having a composition comprising 60˜85% by weight of thermoplastic elastomer, 10˜30% by weight of polyolefin, and 5˜10% by weight of an adhesive.

2. The soft applicator tip of claim 1, wherein the polyolefin is PE.

3. The soft applicator tip of claim 1, wherein the polyolefin is PP.

4. The soft applicator tip of claim 1, wherein the adhesive is a modified polyolefin adhesive resin.

5. An applicator comprising:
a tubular container made of polyolefin; and
a soft applicator tip bonded to said tubular container and having a composition including 60˜85% by weight of thermoplastic elastomer, 10˜30% by weight of polyolefin, and 5˜10% by weight of an adhesive.

6. The soft applicator tip of claim 5, wherein the polyolefin is PE.

7. The soft applicator tip of claim 5, wherein the polyolefin is PP.

8. The soft applicator tip of claim 5, wherein the adhesive is a modified polyolefin adhesive resin.
